(19) United States
(12) Patent Application Publication
(10) Pub. No.: US 2026/0188145 A1
(43) Pub. Date: Jul. 2, 2026

(54) FIXING STRUCTURE AND DISPLAY

(71) Applicant: AUO Corporation, Hsinchu City (TW)

(72) Inventor: Ya-Ting HO, Hsinchu City (TW)

(73) Assignee: AUO Corporation, Hsinchu City (TW)

(21) Appl. No.: 19/403,993

(22) Filed: Nov. 30, 2025

(30) Foreign Application Priority Data
Dec. 30, 2024 (TW) 113151479

(51) Int. Cl. G09F 9/33

(52) U.S. Cl. CPC G09F 9/33

(57) ABSTRACT

A fixing structure adapted to a display includes a light guide plate, an optical film, and a single-side tape. The light guide plate has a first substrate and a first lug portion. The first lug portion is connected to the first substrate. The optical film has a second substrate and a second lug portion. The second lug portion is connected to the second substrate and adjacent to the first lug portion. The single-side tape has a bonding surface. The bonding surface is bonded to the first lug portion and the second lug portion.

### CROSS-REFERENCE TO RELATED APPLICATION

This application claims the priority benefit of Taiwan application serial no. 113151479, filed on December 30, 2024. The entirety of the above-mentioned patent application is hereby incorporated by reference herein and made a part of this specification.

### BACKGROUND OF THE INVENTION

### Field of the Invention

The invention relates to a fixing structure and a display, and more particularly to a fixing structure adapted to a display.

### Description of Related Art

Existing displays are widely used in backend applications, including home and industrial settings, and even in current passenger vehicles as in-vehicle infotainment systems. As a result, the operating temperature of displays varies significantly, ranging from tens of degrees Celsius below zero to tens of degrees Celsius above zero. This causes gaps of different sizes to form in the light guide plates and optical films within the display due to the thermal expansion and contraction of the materials. Consequently, different gap sizes result in varying degrees of abnormal noise due to different vibrations. Therefore, how to reduce abnormal noises caused by vibration in displays is an important issue in the art.

### SUMMARY OF THE INVENTION

The invention provides a fixing structure and a display with excellent component fixing performance to help reduce abnormal noise caused by vibration.

A fixing structure of the invention is adapted to a display and includes a light guide plate, an optical film, and a single-side tape. The light guide plate has a first substrate and a first lug portion. The first lug portion is connected to the first substrate. The optical film has a second substrate and a second lug portion. The second lug portion is connected to the second substrate and adjacent to the first lug portion. The single-side tape has a bonding surface. The bonding surface is bonded to the first lug portion and the second lug portion.

A display of the invention includes a fixing structure. The fixing structure is located on the light-incident side of the display. The fixing structure includes a light guide plate, an optical film, and a single-side tape. The light guide plate has a first substrate and a first lug portion. The first lug portion is connected to the first substrate. The optical film has a second substrate and a second lug portion. The second lug portion is connected to the second substrate and adjacent to the first lug portion. The single-side tape has a bonding surface. The bonding surface is bonded to the first lug portion and the second lug portion.

Based on the above, in the fixing structure and the display of an embodiment of the invention, the light guide plate and the optical film are effectively fixed by bonding the bonding surface of the single-side tape to the first lug portion of the light guide plate and the second lug portion of the optical film. Therefore, excellent component fixing performance is achieved to help reduce abnormal noise caused by vibration.

In addition, the light guide plate, the optical film, and the single-side tape are located on the light-incident side of the display. The single-side tape may be made of an opaque material. The optical film is located between the single-side tape and the light guide plate. In other words, the opaque single-side tape is attached to the outermost side. Therefore, the single-side tape has a good light-blocking effect on the light-incident side. Attaching the single-side tape to the outermost side also allows for intuitive confirmation that the optical film is well fixed.

### BRIEF DESCRIPTION OF THE DRAWINGS

FIG. 1 is a schematic diagram of a partial component of a fixing structure of an embodiment of the invention.

FIG. 2 is an enlarged schematic diagram of the fixing structure of FIG. 1 in a region A.

FIG. 3 is an enlarged schematic diagram of the fixing structure of FIG. 1 in a region B.

FIG. 4 is a schematic diagram of the fixing structure of FIG. 2 with a single-side tape mounted.

FIG. 5 is a cross-sectional view of the fixing structure of FIG. 1 corresponding to the region A.

FIG. 6 is an enlarged schematic diagram of the fixing structure of FIG. 5 in a region C.

FIG. 7 is an enlarged schematic diagram of the fixing structure of FIG. 5 in a region D.

### DESCRIPTION OF THE EMBODIMENTS

As used herein, “about,” “approximately,” “essentially,” or “substantially” include the values and averages within an acceptable range of deviations from a particular value as determined by one of ordinary skill in the art, taking into account the measurement in question and the specific amount of error associated with the measurement (i.e., limitations of the measurement system). For example, “about” may mean within one or a plurality of standard deviations of the value, or for example, within ±30%, ±20%, ±15%, ±10%, ±5%. Furthermore, the terms “about,” “approximately,” “essentially,” or “substantially” used in this article may be chosen to select a more acceptable range of deviations or standard deviations based on the measurement properties, cutting properties, or other properties, rather than applying a single standard deviation to all properties.

In the accompanying drawings, the thickness of layers, films, panels, areas, etc., is enlarged for clarity. It should be understood that when an element such as a layer, film, region, or substrate is referred to as being “on” or “connected to” another element, it may be directly on or connected to the other element, or an intermediate element may also be present. Conversely, when an element is referred to as “directly on another element” or “directly connected to” another element, there is no intermediate element. As used in this article, “connection” may refer to physical and/or electrical connection. Furthermore, “electrical connection” may mean that there are other elements between the two elements.

In addition, relative terms such as “down” or “bottom” and “up” or “top” may be used in this document to describe the relationship between one element and another element, as shown in the figures. It should be understood that relative terms are intended to include different orientations of the device other than the orientations shown in the figures. For example, if the device in one of the figures is flipped, the element described as being “below” the other elements is oriented “above” the other elements. Therefore, the exemplary term “below” may include the orientation of “below” and “above,” depending on the specific orientation of the accompanying drawings. Similarly, if a device in an accompanying drawing is flipped, an element described as being “below” or “below” the other elements is oriented as “above” the other elements. Therefore, the exemplary terms “above” or “below” may include orientations of above and below.

This document describes exemplary embodiments with reference to cross-sectional views, which are schematic diagrams of idealized embodiments. Therefore, shape variations in the diagram may be expected as a result of, for example, manufacturing techniques and/or tolerances. Therefore, the embodiments described herein should not be construed as limited to a specific shape of the region as shown herein, but rather include, for example, shape deviations caused by manufacturing. For example, regions shown or described as flat may often have rough and/or nonlinear characteristics. Furthermore, the acute angle shown may be rounded. Therefore, the regions shown in the figures are schematic in nature, and their shapes are not intended to show the precise shape of the regions, nor are they intended to limit the scope of the claims.

The exemplary embodiments of the invention will now be described in detail with reference to the accompanying drawings. Whenever possible, the same reference numerals are used in diagrams and descriptions to represent the same or similar parts.

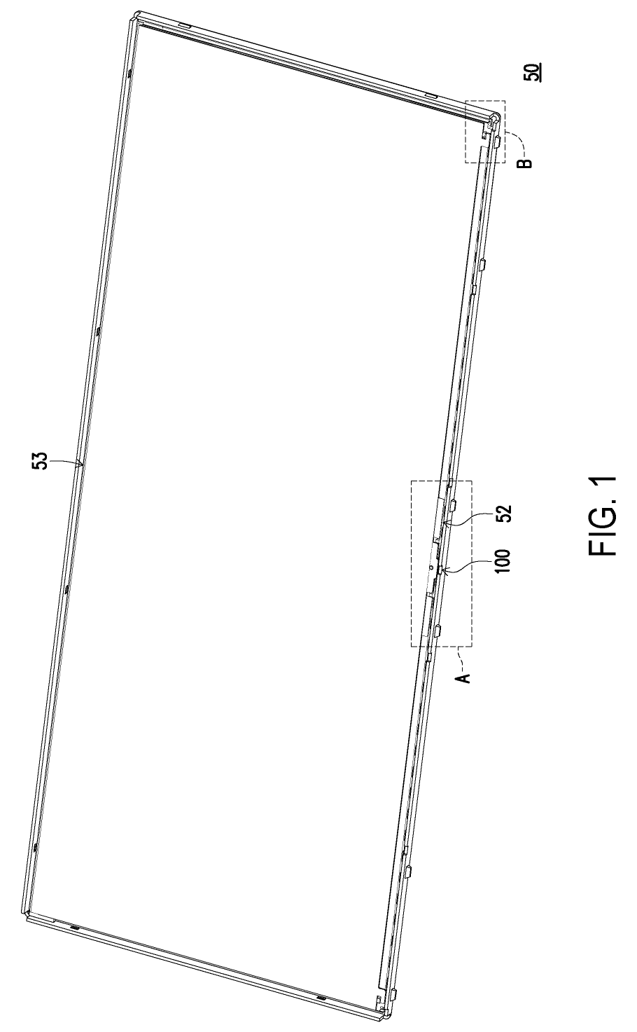

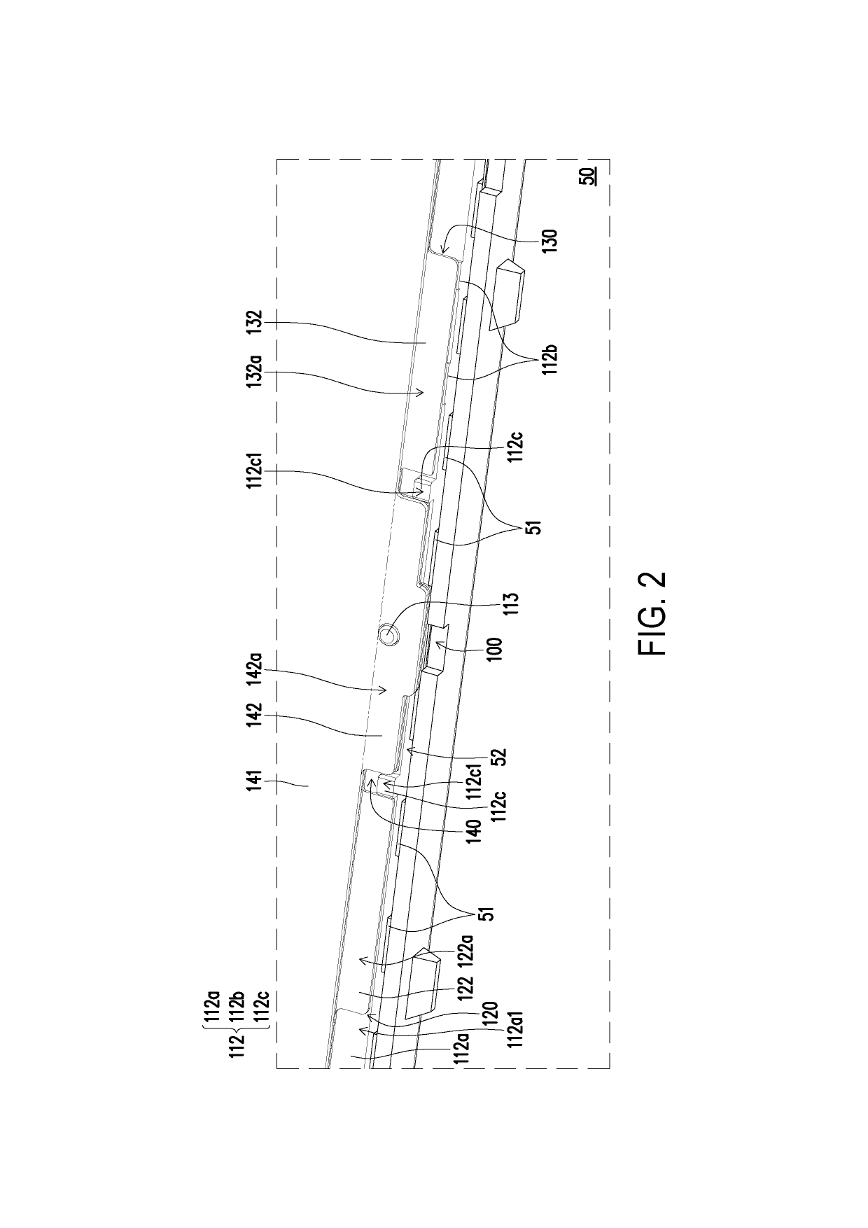

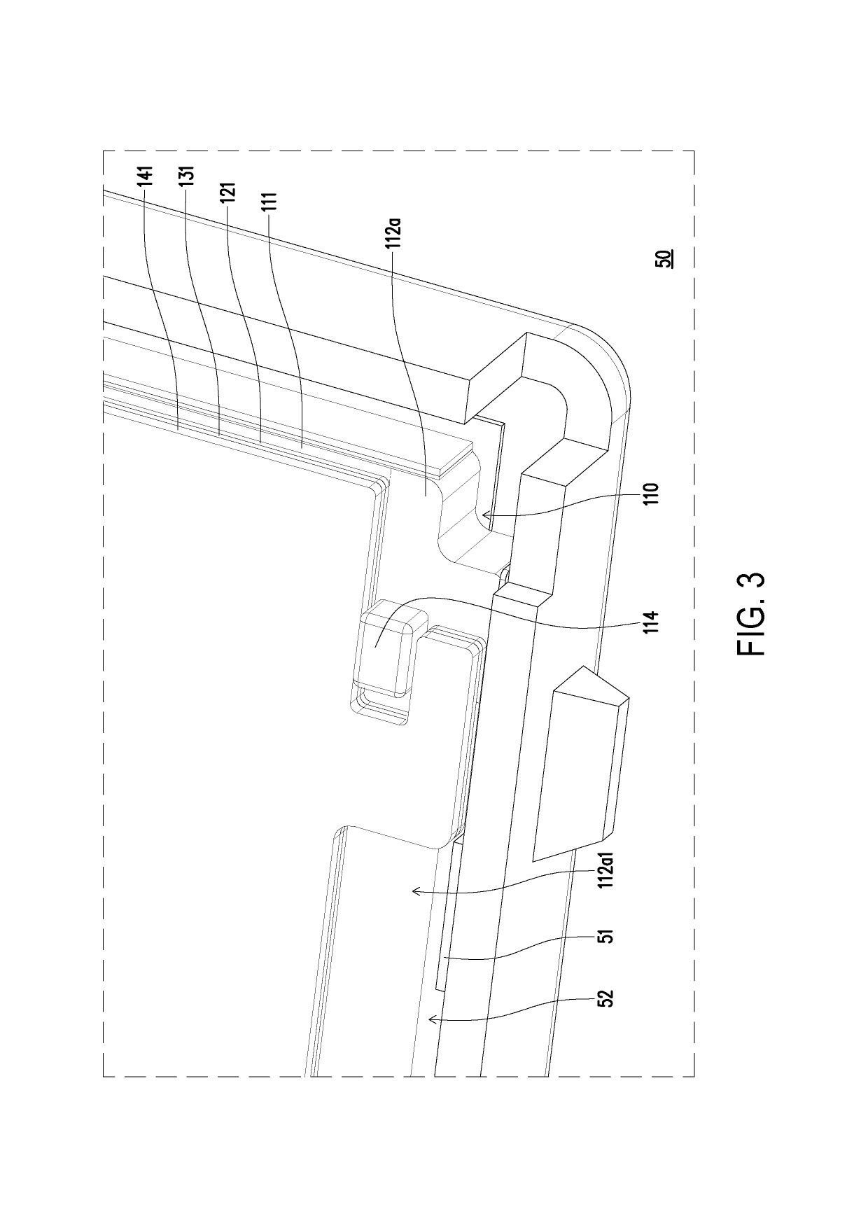

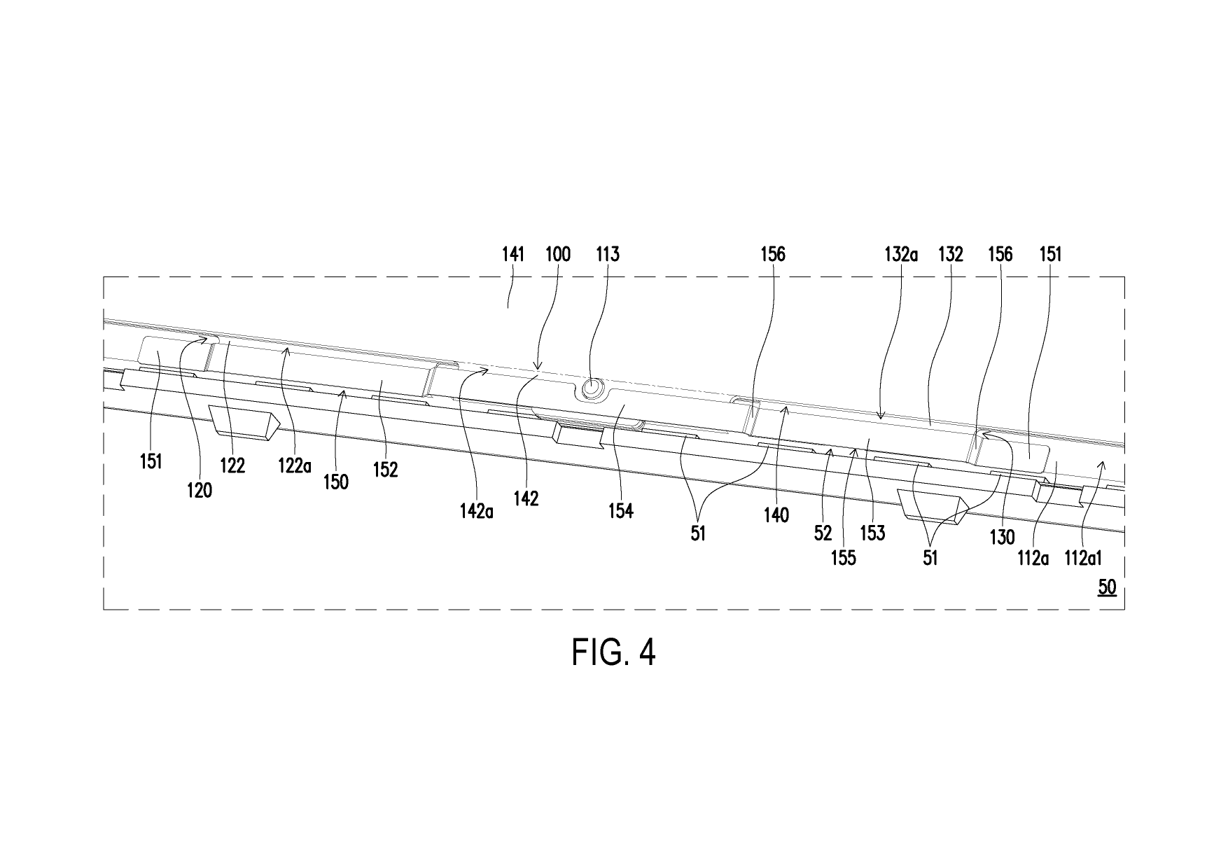

FIG. 1 is a schematic diagram of a partial component of a fixing structure of an embodiment of the invention. FIG. 2 is an enlarged schematic diagram of the fixing structure of FIG. 1 in a region A. FIG. 3 is an enlarged schematic diagram of the fixing structure of FIG. 1 in a region B. FIG. 4 is a schematic diagram of the fixing structure in FIG. 2 with a single-side tape mounted.

Please refer to FIG. 1, FIG. 2, FIG. 3, and FIG. 4. A fixing structure 100 of the invention is adapted to a display 50. The necessary components of the display 50 are well known to those skilled in the art and will not be described in detail here. The fixing structure 100 includes a light guide plate 110, at least one optical film, and a single-side tape 150. The light guide plate 110 has a first substrate 111 and a first lug portion 112, and the first lug portion 112 is connected to the first substrate 111. The optical film has a second substrate 121 and a second lug portion 122, and the second lug portion 122 is connected to the second substrate 121 and adjacent to the first lug portion 112. The single-side tape 150 has a bonding surface 155, and the bonding surface 155 is bonded to the first lug portion 112 and the second lug portion 122. By bonding the bonding surface 155 of the single-side tape 150 to the first lug portion 112 of the light guide plate 110 and the second lug portion 122 of the optical film, the light guide plate 110 and the optical film may be effectively fixed. Therefore, the fixing structure 100 of the invention has excellent component fixing performance and helps to reduce abnormal noise caused by vibration.

In addition, the display 50 has a light-emitting element 51, and a light-incident side 52 and a non-light-incident side 53 opposite to each other. The light-emitting element 51, the first lug portion 112 of the light guide plate 110, the second lug portion 122 of the optical film, and the single-side tape 150 are located on the light-incident side 52 of the display 50. The light-emitting element 51 may be a light-emitting diode. The single-side tape 150 may be made of an opaque material. The optical film is located between the single-side tape 150 and the light guide plate 110. In other words, the opaque single-side tape 150 is attached to the outermost side. Therefore, the single-side tape 150 has a good light-shielding effect on the light-incident side 52. Attaching the single-side tape 150 to the outermost side also allows for intuitive confirmation of whether the optical film is well fixed. However, the invention is not limited thereto.

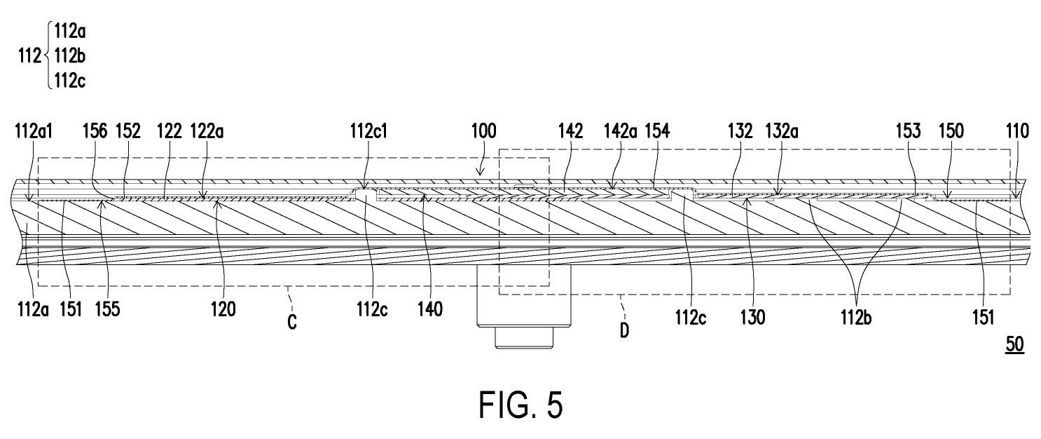

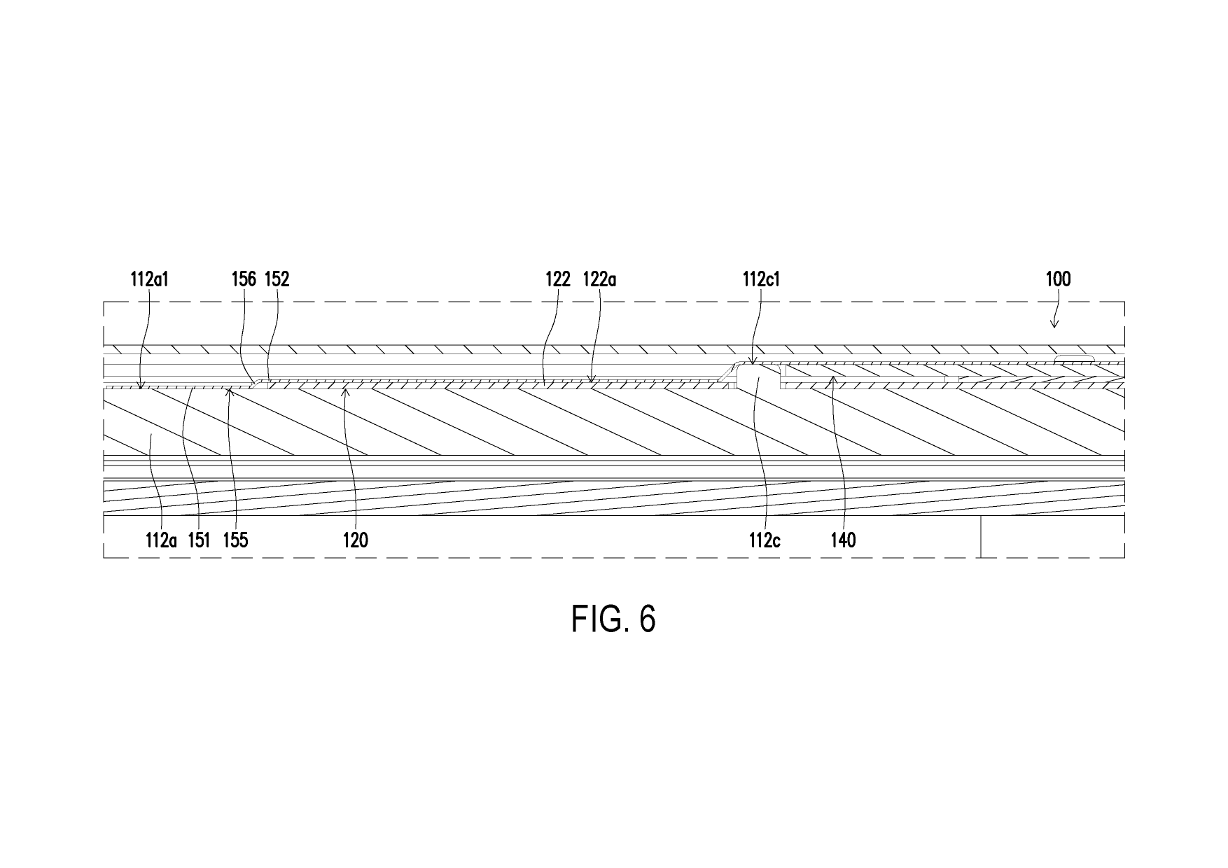

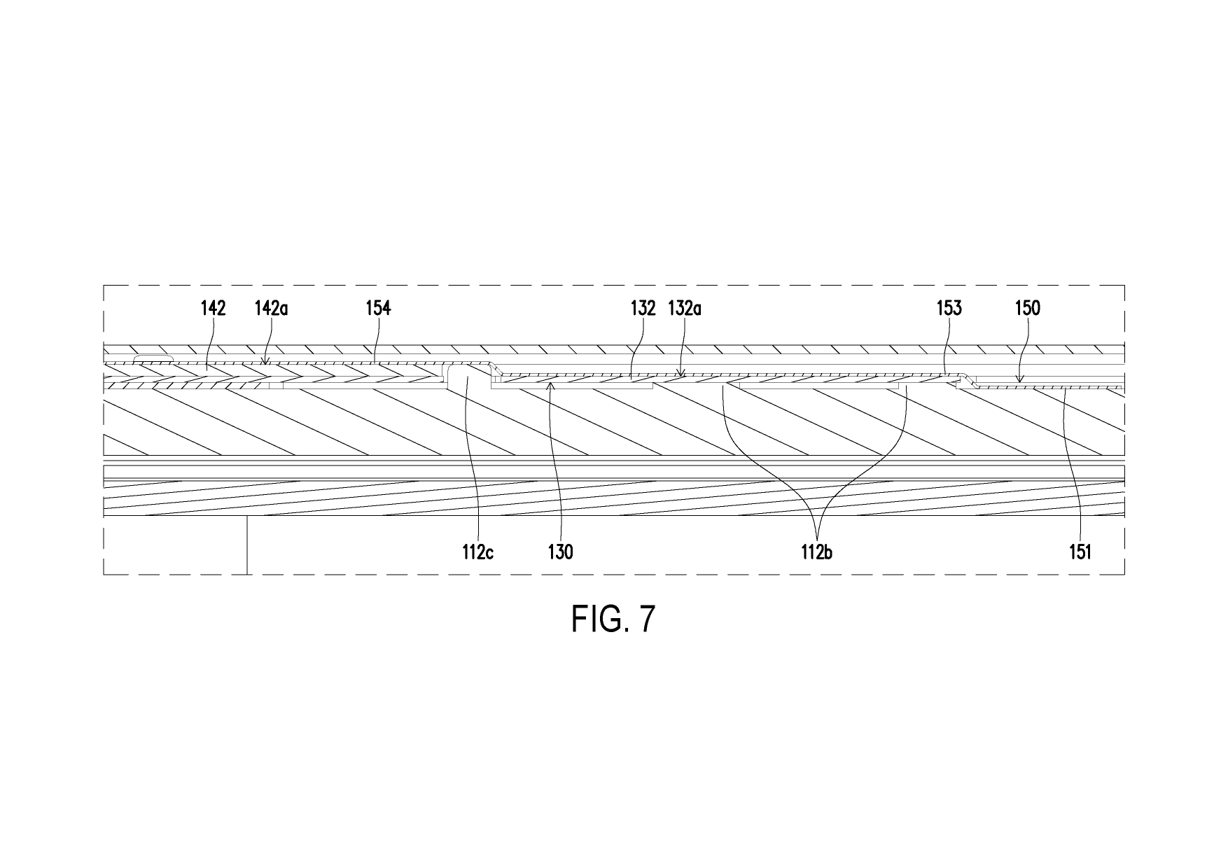

FIG. 5 is a cross-sectional view of the fixing structure of FIG. 1 corresponding to the region A. FIG. 6 is an enlarged schematic diagram of the fixing structure of FIG. 5 in a region C. FIG. 7 is an enlarged schematic diagram of the fixing structure of FIG. 5 in a region D.

Please refer to FIG. 2, FIG. 3, FIG. 5, FIG. 6, and FIG. 7. In an embodiment, the first lug portion 112 has an extension portion 112a, and the extension portion 112a is connected to the first substrate 111 and has a first surface 112a1. The single-side tape 150 has a first bonding segment 151, and the bonding surface 155 of the first bonding segment 151 is bonded to the first surface 112a1. In an embodiment, the fixing structure 100 further includes a first optical film 120, the first optical film 120 has a second substrate 121 and a second lug portion 122, the second lug portion 122 has a second surface 122a, the single-side tape 150 has a second bonding segment 152, the bonding surface 155 of the second bonding segment 152 is bonded to the second surface 122a, and the second lug portion 122 is located between the second bonding segment 152 and the extension portion 112a.

In an embodiment, the second lug portion 122 is flat against the first surface 112a1. Since the light guide plate 110 has no recess, the light guiding effect thereof is good.

In an embodiment, the first lug portion 112 further has a first protrusion 112b, the first protrusion 112b is connected to the extension portion 112a, and the first protrusion 112b is protruded beyond the first surface 112a1, wherein the fixing structure 100 further includes a second optical film 130. The second optical film 130 has a third substrate 131 and a third lug portion 132. The third lug portion 132 is connected to the third substrate 131. The third lug portion 132 is adjacent to the first protrusion 112b. The third lug portion 132 has a third surface 132a. The single-side tape 150 has a third bonding segment 153. The bonding surface 155 of the third bonding segment 153 is bonded to the third surface 132a, and the third lug portion 132 is located between the third bonding segment 153 and the first protrusion 112b.

In an embodiment, the first lug portion 112 further has a second protrusion 112c, the second protrusion 112c is connected to the extension portion 112a, and the second protrusion 112c is protruded beyond the first surface 112a1, wherein the fixing structure 100 further includes a third optical film 140. The third optical film 140 has a fourth substrate 141 and a fourth lug portion 142. The fourth lug portion 142 is connected to the fourth substrate 141. The fourth lug portion 142 is adjacent to the second protrusion 112c. The fourth lug portion 142 has a fourth surface 142a. The second protrusion 112c has a fifth surface 112c1. The single-side tape 150 has a fourth bonding segment 154. The bonding surface 155 of the fourth bonding segment 154 is bonded to the fourth surface 142a and the fifth surface 112c1, and the fourth lug portion 142 is located between the fourth bonding segment 154 and the extension portion 112a.

Please refer to FIG. 2, FIG. 3, FIG. 5, FIG. 6, and FIG. 7. It should be noted that the first lug portion 112 is the portion connected to the first substrate 111 and extended from the first substrate 111 and includes portion such as the extension portion 112a connected to the first substrate 111, the first protrusion 112b protruded from the first surface 112a1 of the extension portion 112a, and the second protrusion 112c protruded from the first surface 112a1 of the extension portion 112a. However, the invention is not limited thereto.

Please refer to FIG. 1, FIG. 2, FIG. 3, and FIG. 4. The fourth lug portion 142 is the portion connected to the fourth substrate 141 and extended from the fourth substrate 141. For ease of explanation, a dotted chain line is used in FIG. 2 to distinguish the boundary between the fourth substrate 141 and the fourth lug portion 142. However, this boundary line is only a provisional measure to facilitate the reader’s understanding and is not intended to limit the invention. The invention is not limited to what is described herein. The definition principle between the first substrate 111 and the first lug portion 112, the second substrate 121 and the second lug portion 122, and the third substrate 131 and the third lug portion 132 is also the same. For the sake of simplicity, it will not be repeated here.

Furthermore, the two adjacent lug portions may be configured to partially or completely overlap, depending on the requirements, and the invention is not limited thereto.

Please refer to FIG. 2, FIG. 3, FIG. 5, FIG. 6, and FIG. 7. In an embodiment, the height of the second protrusion 112c is different from the height of the first protrusion 112b.

In an embodiment, the height of the second protrusion 112c is greater than the height of the first protrusion 112b.

It should be noted that the light guide plate 110 may be designed with protrusions of different heights as needed. Protrusions of different heights may correspond to optical films stacked in different layers. The invention does not limit the number of protrusions or the configuration thereof.

It should be noted that the single-side tape 150 includes a plurality of bonding segments, and the bonding segments are located on different planes. The bonding segments located on different planes may correspond to the light guide plate and the optical films stacked on different layers.

In an embodiment, the display 50 has a plurality of light-emitting elements 51, and the connecting segment 156 between any two adjacent bonding segments is misaligned with the light-emitting elements 51. By misaligning the connecting segment 156 with the light-emitting elements 51, the issue of reduced light guiding effect caused by the light emitted by the light-emitting elements 51 passing through the gap between the connecting segment 156 and the optical film or passing through the gap between the connecting segment 156 and the light guide plate 110 is avoided.

In an embodiment, the single-side tape 150 is formed by sequentially connecting the first bonding segment 151, the second bonding segment 152, the fourth bonding segment 154, the third bonding segment 153, and the first bonding segment 151, but the invention is not limited thereto.

In other embodiments, the fixing structure includes a single optical film and a single segment of a single-side tape. The single segment of the single-side tape directly bonds the single optical film to the first surface of the light guide plate.

In an embodiment, the light guide plate 110 also has a positioning post 113. Since the light guide plate 110 and each optical film are well fixed by the single-side tape 150, the collision between the positioning post 113 and each optical film may be reduced under any temperature and any expansion and contraction conditions, thus effectively reducing noise.

In an embodiment, the light guide plate 110 also has a positioning portion 114. Since the light guide plate 110 and each optical film are well fixed by the single-side tape 150, the collision between the positioning portion 114 and each optical film may be reduced under any temperature and any expansion and contraction conditions, thus effectively reducing abnormal noise.

Based on the above, in the fixing structure and the display of an embodiment of the invention, the light guide plate and the optical film are effectively fixed by bonding the bonding surface of the single-side tape to the first lug portion of the light guide plate and the second lug portion of the optical film. Therefore, excellent component fixing performance is achieved to help reduce abnormal noise caused by vibration.

In addition, the light guide plate, the optical film, and the single-side tape are located on the light-incident side of the display. The single-side tape may be made of an opaque material. The optical film is located between the single-side tape and the light guide plate. In other words, the opaque single-side tape is attached to the outermost side. Therefore, the single-side tape has a good light-blocking effect on the light-incident side. Attaching the single-side tape to the outermost side also allows for intuitive confirmation that the optical film is well fixed.

What is claimed is:

1. A fixing structure, adapted to a display, comprising:
a light guide plate having a first substrate and a first lug portion, and the first lug portion is connected to the first substrate;
at least one optical film having a second substrate and a second lug portion, and the second lug portion is connected to the second substrate and the second lug portion is adjacent to the first lug portion; and
a single-side tape having a bonding surface, wherein the bonding surface is bonded to the first lug portion and the second lug portion.

2. The fixing structure of claim 1, wherein the first lug portion has an extension portion, the extension portion has a first surface, the single-side tape has a first bonding segment, and the bonding surface of the first bonding segment is bonded to the first surface.

3. The fixing structure of claim 2, further comprising a first optical film, the first optical film has the second substrate and the second lug portion, the second lug portion has a second surface, the single-side tape has a second bonding segment, the bonding surface of the second bonding segment is bonded to the second surface, and the second lug portion is located between the second bonding segment and the extension portion.

4. The fixing structure of claim 3, wherein the second lug portion is flat against the first surface.

5. The fixing structure of claim 3, wherein the first lug portion further has a first protrusion, the first protrusion is connected to the extension portion and the first protrusion is protruded beyond the first surface, wherein the fixing structure further comprises a second optical film having a third substrate and a third lug portion, the third lug portion is connected to the third substrate, the third lug portion is adjacent to the first protrusion, the third lug portion has a third surface, the single-side tape has a third bonding segment, the bonding surface of the third bonding segment is bonded to the third surface, and the third lug portion is located between the third bonding segment and the first protrusion.

6. The fixing structure of claim 5, wherein the first lug portion further has a second protrusion, the second protrusion is connected to the extension portion, and the second protrusion is protruded beyond the first surface, wherein the fixing structure further comprises a third optical film, the third optical film has a fourth substrate and a fourth lug portion, the fourth lug portion is connected to the fourth substrate, the fourth lug portion is adjacent to the second protrusion, the fourth lug portion has a fourth surface, the second protrusion has a fifth surface, the single-side tape has a fourth bonding segment, the bonding surface of the fourth bonding segment is bonded to the fourth surface and the fifth surface, and the fourth lug portion is located between the fourth bonding segment and the extension portion.

7. The fixing structure of claim 6, wherein a height of the second protrusion is different from a height of the first protrusion.

8. The fixing structure of claim 1, wherein the single-side tape comprises a plurality of bonding segments and the bonding segments are located on different planes.

9. The fixing structure of claim 8, wherein the display has a plurality of light-emitting elements, and a connecting segment between any two adjacent bonding segments is misaligned with the light-emitting elements.

10. The fixing structure of claim 1, wherein the first lug portion of the light guide plate, the second lug portion of the at least one optical film, and the single-side tape are located on a light-incident side of the display.

11. A display, comprising:
a fixing structure located on a light-incident side of the display and comprising:
a light guide plate having a first substrate and a first lug portion, and the first lug portion is connected to the first substrate;
at least one optical film having a second substrate and a second lug portion, the second lug portion is connected to the second substrate, and the second lug portion is adjacent to the first lug portion; and
a single-side tape having a bonding surface, wherein the bonding surface is bonded to the first lug portion and the second lug portion.

12. The display of claim 11, wherein the first lug portion has an extension portion, the extension portion has a first surface, the single-side tape has a first bonding segment, and the bonding surface of the first bonding segment is bonded to the first surface.

13. The display of claim 12, wherein the fixing structure further comprises a first optical film, the first optical film has the second substrate and the second lug portion, the second lug portion has a second surface, the single-side tape has a second bonding segment, the bonding surface of the second bonding segment is bonded to the second surface, and the second lug portion is located between the second bonding segment and the extension portion.

14. The display of claim 13, wherein the second lug portion is flat against the first surface.

15. The display of claim 13, wherein the first lug portion further has a first protrusion, the first protrusion is connected to the extension portion, and the first protrusion is protruded beyond the first surface, wherein the fixing structure further comprises a second optical film, the second optical film has a third substrate and a third lug portion, the third lug portion is connected to the third substrate, the third lug portion is adjacent to the first protrusion, the third lug portion has a third surface, the single-side tape has a third bonding segment, the bonding surface of the third bonding segment is bonded to the third surface, and the third lug portion is located between the third bonding segment and the first protrusion.

16. The display of claim 15, wherein the first lug portion further has a second protrusion, the second protrusion is connected to the extension portion, and the second protrusion is protruded beyond the first surface, wherein the fixing structure further comprises a third optical film, the third optical film has a fourth substrate and a fourth lug portion, the fourth lug portion is connected to the fourth substrate, the fourth lug portion is adjacent to the second protrusion, the fourth lug portion has a fourth surface, the second protrusion has a fifth surface, the single-side tape has a fourth bonding segment, the bonding surface of the fourth bonding segment is bonded to the fourth surface and the fifth surface, and the fourth lug portion is located between the fourth bonding segment and the extension portion.

17. The display of claim 16, wherein a height of the second protrusion is different from a height of the first protrusion.

18. The display of claim 11, wherein the single-side tape comprises a plurality of bonding segments and the bonding segments are located on different planes.

19. The display of claim 18, wherein the display has a plurality of light-emitting elements, and a connecting segment between any two adjacent bonding segments is misaligned with the light-emitting elements.

20. The display of claim 11, wherein the first lug portion of the light guide plate, the second lug portion of the at least one optical film, and the single-side tape are located on a light-incident side of the display.
